(19) United States
(12) Patent Application Publication
(10) Pub. No.: US 2015/0315490 A1
(43) Pub. Date: Nov. 5, 2015

(54) SYSTEMS AND METHODS FOR INCREASING DEASPHALTED OIL YIELD OR QUALITY

(71) Applicants: Patrick Loring Hanks, Bridgewater, NJ (US); Michel Daage, Hellertown, PA (US); Thomas Francis Degnan, JR., Philadelphia, PA (US)

(72) Inventors: Patrick Loring Hanks, Bridgewater, NJ (US); Michel Daage, Hellertown, PA (US); Thomas Francis Degnan, JR., Philadelphia, PA (US)

(73) Assignee: ExxonMobile Research and Engineering Company, Annandale, NJ (US)

(21) Appl. No.: 14/691,931

(22) Filed: Apr. 21, 2015

Related U.S. Application Data
(60) Provisional application No. 61/986,938, filed on May 1, 2014.

(51) Int. Cl. C10G 55/02; C01B 3/02; C10G 55/04; B01J 19/24; C10G 55/06; C10G 69/02

(52) U.S. Cl. CPC C10G 55/02; C10G 55/06; C10G 69/02; C10G 55/04; B01J 19/24; C01B 3/02; B01J 2219/24

(57) ABSTRACT

Systems and methods are provided for deasphalting with integrated hydrodynamic cavitation to improve the yield or quality of deasphalted oil obtained from a deasphalting unit.

### CROSS-REFERENCE TO RELATED APPLICATION

The present application claims priority to U.S. patent application Ser. No. 61/986,938, filed May 1, 2014.

### FIELD

The present invention relates to methods and systems for separation of deasphalted oil and asphaltenes. More particularly, the present invention relates to systems and methods of deasphalting with integrated hydrodynamic cavitation to improve the quality of the deasphalted oil.

### BACKGROUND

Deasphalting units are used to remove asphaltenes from hydrocarbon containing streams, so that each component stream may be further converted to more valuable products. Asphaltenes are generally separated as a rock/asphalt fraction and the deasphalted oil is generally sent to a conversion unit or lubricants plant.

There remains a desire to improve yields of deasphalted oil obtained from deasphalting units while maintaining or improving the quality of the deasphalted oil. There also remains a desire to improve the separation and concentration of metals and Conradson carbon residue (CCR) in the rock/asphalt fraction.

### SUMMARY

The present invention addresses these and other problems by providing systems and methods for deasphalting with integrated hydrodynamic cavitation to improve the yield or quality of deasphalted oil obtained from a deasphalting unit.

In one aspect, a method is provided for improving deasphalted oil yield or quality from a deasphalting unit. The method includes subjecting a resid-containing stream to hydrodynamic cavitation in a hydrodynamic cavitation unit to convert a portion of hydrocarbons in the resid-containing stream to lower molecular weight hydrocarbons and thereby produce a cavitated resid stream; and subjecting at least a portion of the cavitated resid stream to solvent deasphalting to separate a deasphalted oil rich stream from an asphaltene rich stream. In another aspect, a system is provided for improving deasphalted oil yield or quality from a deasphalting unit. The system includes a resid-containing feed stream; a hydrodynamic cavitation unit receiving the resid-containing stream and adapted subject the resid-containing feed stream to hydrodynamic cavitation in a hydrodynamic cavitation unit to convert a portion of hydrocarbons in the resid-containing feed stream to lower molecular weight hydrocarbons and thereby produce a cavitated resid stream; and a deasphalting unit receiving the cavitated resid stream and adapted to subject the cavitated resid stream to solvent deasphalting and separate a deasphalted oil rich stream from an asphaltene rich stream.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for improving the liquid product yield from deasphalting units, according to one or more embodiments of the present invention.

### DETAILED DESCRIPTION

Systems and methods are provided herein for improving deasphalted oil yield and/or from a deasphalting unit. The improvement may be in the form of higher deasphalted oil quality at the same or improved yield, higher deasphalted oil yield at the same or improved quality, reduction in solvent to oil ratio with the same or improved quality, or a combination of the foregoing. Such improvements may be achieved using hydrodynamic cavitation of resid streams to crack larger hydrocarbons to produce lower molecular weight hydrocarbons, in particular, cracking asphaltenes or other large molecules to dealkylate side chains. Such systems and methods may be employed with fuel deasphalters and lubricant deasphalters.

Suitable feeds include those that are normally processed by deasphalting units, such as solvent deasphalting units. Preferably, the feed is a resid-containing feed stream having an API gravity of less than 22. A resid-containing stream is defined as having a portion of material boiling above 1050° F. For example, the feed stream may be a resid stream such as a vacuum resid stream from the bottom of a vacuum distillation unit or an atmospheric resid from the bottom of atmospheric distillation unit. The feed may have a T5 boiling point (the temperature at which 5 wt % of the material boils off at atmospheric pressure) of at least 500° F., or more preferably at least 680° F.

The resid stream may comprise a significant amount of asphaltenes relative to the total weight of the stream. Asphaltenes can be considered as those components not soluble in n-heptane as determined by ASTM D3279. For example, the resid stream may comprise 5 to 80 wt % asphaltenes, or 5 to 60 wt % asphaltenes, or 10 to 50 wt % asphaltenes, or 20 to 50 wt % asphaltenes, based on the total weight of the resid stream. Similarly, the feed stream for the methods and systems disclosed herein may be produced by fractionating a mixture of crude oil hydrocarbons to a cut-point of around 1000° F. to remove naphtha, distillate, and vacuum gas oil range fractions. The resid feed stream, therefore, may have a T95 (the temperature at which most all the material has boiled off, leaving only 5% remaining in the distillation pot) of at least 1000° F.

Advantageously, the methods and systems disclosed herein may reduce the metal and Conradson carbon residue (CCR) content of the deasphalted oil to a greater extent than without hydrodynamic cavitation. CCR can be measured by ASTM D4530, and metals of importance such as iron, nickel, and vanadium can be measured by ASTM D5708. Furthermore, very high levels of metal reduction may be achieved in the deasphalted oil relative to the resid-containing stream that is fed to the hydrodynamic cavitation unit. For example, a nickel content reduction of at least 65%, or at least 70%, or at least 75%, or at least 80% may be attained. In addition, a vanadium content reduction of at least 75%, or at least 80%, or at least 85%, or at least 90%, or at least 95% may be attained. Nickel and vanadium reductions may be as high as 99% depending upon the solvent that is employed in the deasphalting unit.

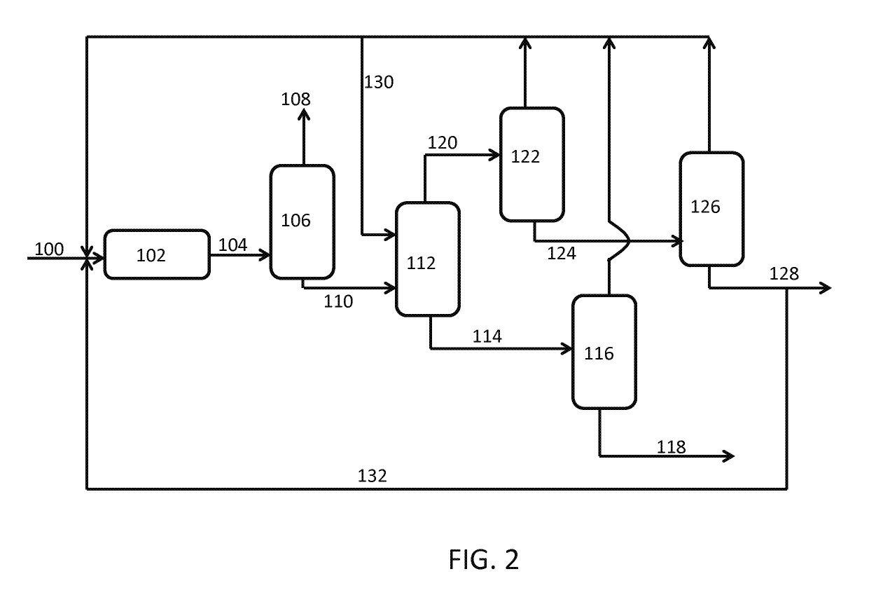

In an exemplary embodiment, as illustrated in FIG. 2, a resid stream 100 is fed to a hydrodynamic cavitation unit 102 where the stream is subjected to hydrodynamic cavitation. Aspects and operation of the hydrodynamic cavitation unit 102 are described in greater detail subsequently herein. When subjected to hydrodynamic cavitation, a portion of the resid stream 100 is converted to lower molecular weight hydrocarbons. In particular, side chains are dealkylated from large asphaltene molecules through cracking and free radical reactions.

The cavitated resid feed 104 may be fed to a separating unit 106 where light ends 108 are separated from the cavitated resid stream 104. The light ends 108 may be recycled to an upstream fractionation unit or to a conversion or treatment unit for further processing.

The remaining resid stream 110 may then be fed to solvent deasphalting unit 112 with solvent feed 130. The solvent may be any solvent suitable for promoting the separation of asphaltenes from deasphalted oil, such as propane or butane or pentane. Any type of deasphalting unit suitable for separating asphaltene hydrocarbons from deasphalted oil may be employed in the systems and methods disclosed herein. Solvent and deasphalting unit selections are typically determined by the quality and composition of the feed stream and the end-use application of the deasphalted oil e.g., whether deasphalted oil will be used in a fuel or lubricant application. In any embodiment, the solvent deasphalting unit may operate by liquid-liquid separation in which asphaltenes precipitate out of the mixture and the deasphalted oil hydrocarbons are dissolved in the solvent. The asphaltenes are carried out of solvent deasphalting unit 112 in asphaltene-rich stream 114, which is fed to a stripper 116 to separate the solvent from the asphaltenes. The recovered asphaltenes are collected from stream 118.

The deasphalted oil rich stream 120 leaving solvent deasphalting unit 112 is fed to a subsequent solvent recovery unit 122 for recovery of solvent. The deasphalted oil rich stream of solvent recovery unit 122 is then fed to a stripper 126 for additional solvent recovery. The deasphalted oil stream 128 leaving stripper 126 may then be blended with another product stream and/or sent to a fluid catalytic cracker or a hydrocracker for conversion into more valuable products.

As illustrated in FIG. 2, solvent and/or deasphalted oil 132 may be recycled upstream of the hydrodynamic cavitation unit 102 to modify the resid stream 100 before it is subjected to hydrodynamic cavitation. By adding a lower viscosity cutter stock to the resid stream 100, the viscosity of resid stream 100 is reduced thereby reducing the dampening effect caused by the higher viscosity of the resid stream 100, enabling for greater energy to be transmitted into cracking bonds of the hydrocarbons during the bubble implosion phase of cavitation.

Although the foregoing description applies to fuels and lubricant deasphalting, in lubricant deasphalting applications it may be beneficial to place the cavitation device downstream of the lubricant deasphalting unit on the asphalt stream, in order to avoid cracking molecules having desirable lubricant properties. In an exemplary embodiment, a resid-containing stream may be fed to a lubricant deasphalting unit where a lubricant intermediate is separated from lubricant rock. The lubricant rock may then be fed to a hydrodynamic cavitation unit where the lubricant rock is subjected to hydrodynamic cavitation to convert at least a portion of the hydrocarbons in the lubricant rock to lower molecular weight hydrocarbons, thereby producing a stream of cavitated lubricant rock.

A portion of the cavitated lubricant rock may be recycled to the lubricant deasphalting unit. This portion may be 0.5 to 99.5 wt % of the cavitated lubricant rock stream depending on the hydraulic capacity of the lubricant deasphalting unit. The cavitated lubricant rock may be used to increase the yield of bright stock without destroying and nascent lube molecules in the resid.

The remainder of the cavitated lubricant rock may be further fed to a fuels deasphalting unit where deasphalted oil is separated from the asphaltenes. The deasphalted oil may be fed to a conversion unit such as a fluidized cat cracker or a hydrocracker. Alternatively the remainder of the cavitated lubricant rock may be used as a fuel oil blending component or sent to a coker for additional conversion.

Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

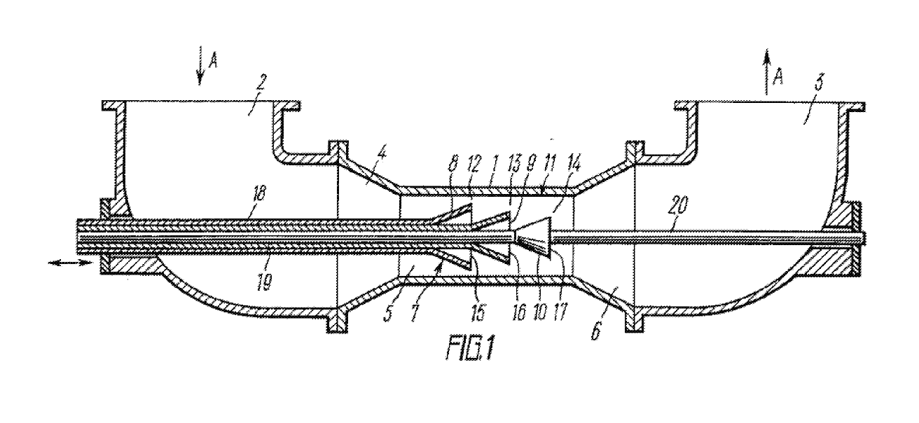

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing 1 having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 winch exceeds tine diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937, 906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles, in the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapse of the cavitation bubbles, For example, the bubble collapse time duration may be on the magnitude of 10⁻³ to 10⁻⁸ second. The precise duration of the collapse is dependent upon the size of the bubbles and the static pressure of the flow. The flow velocities reached during the collapse of the vacuum may he 100-1000 times faster than the first velocity or 6-100 times faster than the second. velocity. in this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000 K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (ie, free radical cracking of hydrocarbons and dealkylation of side chains) occurs. The rapid velocities achieved during the implosion generate a shockwave that can: (1) mechanically disrupt agglomerates (such as asphaltene agglomerates or agglomerated particulates), (2) create emulsions with small mean droplet diameters, and (3) reduce mean particulate size in a slurry.

The hydrodynamic cavitation unit 102 may comprise one or more cavitation devices, and each cavitation device may comprise one or more cavitation stages. if multiple cavitation devices are employed, they may be arranged in parallel or series. Between cavitation devices employed in series, pumps may be employed to adjust fluid pressure between devices. Furthermore, heat exchanger equipment may be employed between cavitation devices to heat or cool the liquid to modify vapor pressure and viscosity of the fluid. Also, vapor-liquid separation devices may he employed between cavitation devices to remove light ends and/or to modify vapor pressure and amount of dissolved gas in the liquid. Fractions from separation devices, such as light ends or naphtha, may be removed to bypass the deasphalter. Also, recycle solvent, deasphalted oil, or products from various units may be added between cavitation devices to achieve desired stream viscosity or composition.

Specific Embodiments

In order to better illustrate aspects of the present invention, the following specific embodiments are provided:

Paragraph A—A method of improving deasphalted oil yield or quality from a deasphalting unit comprising subjecting a resid-containing stream to hydrodynamic cavitation in a hydrodynamic cavitation unit to convert a portion of hydrocarbons in the resid-containing stream to lower molecular weight hydrocarbons and thereby produce a cavitated resid stream and subjecting at least a portion of the cavitated resid stream to solvent deasphalting to separate a deasphalted oil-rich stream from an asphaltene-rich stream,

Paragraph B—The method of Paragraph A, wherein the resid-containing stream is at least 50 wt % vacuum or atmospheric resid,

Paragraph C—The method of Paragraph B, wherein the resid-containing stream is at least 80 wt % vacuum or atmospheric resid.

Paragraph D—The method of any of Paragraphs A-C, wherein the resid-containing stream is vacuum resid.

Paragraph E—The method of any of Paragraphs A-D, wherein the resid-containing stream has a T95 of 1000° F. or greater.

Paragraph F—The method of any of Paragraphs A-E, wherein the resid-containing stream comprises a 1050+° F. boiling fraction, and about 1 to about 35 wt % of the 1050+° F. boiling fraction is converted when subjected to hydrodynamic cavitation.

Paragraph G—The method of any of Paragraphs A-F, wherein the resid-containing stream is subjected to a pressure drop greater than 400 psig, or more preferably greater than 1000 psig, or even more preferably greater than 2000 psig when subjected to hydrodynamic cavitation.

Paragraph H—The method of any of Paragraphs A-G, wherein the resid-containing stream comprises lubricant deasphalted rock.

Paragraph I—The method of any of Paragraphs A-H, wherein the deasphalted oil stream has a Ni content that is at least 65% less than that of the resid-containing stream.

Paragraph J—The method of Paragraph I, wherein the deasphalted oil stream has a Ni content that is at least 70% less, or at least 75% less, or at least 80% less than that of the resid-containing stream.

Paragraph K—The method of any of Paragraphs A-J, wherein the deasphalted oil stream has a V content that is at least 80% less than that of the resid-containing stream.

Paragraph L—The method of Paragraph K, wherein the deasphalted oil stream has a V content that is at least 85% less, or at least 90% less, or at least 95% less than that of the resid-containing stream.

Paragraph M—The method of any of Paragraphs A-L, wherein the hydrodynamic cavitation is performed in the absence of a catalyst.

Paragraph N—The method of any of Paragraphs A-M, wherein the hydrodynamic cavitation is performed in the absence of a hydrogen gas or wherein a hydrogen gas is present at a content of less than 50 standard cubic feet per barrel.

Paragraph O—The method of any of Paragraphs A-N, wherein the hydrodynamic cavitation is performed in the absence of water.

Paragraph P—The method of any of Paragraphs A-O, further comprising converting the deasphalted oil stream by at least one of fluidized cat cracking or hydrocracking.

Paragraph Q—The method of any of Paragraphs A-P, further comprising coking, air blowing, or gasifying the asphaltene rich stream.

Paragraph R—The method any of Paragraphs A-Q, further comprising upgrading the deasphalted oil stream by distillation, extraction, hydroprocessing, hydrocracking, fluidized cat cracking, dewaxing, or a combination thereof.

Paragraph S—The method of any of Paragraphs A-R, further comprising upgrading the asphaltene rich stream by distillation, extraction, hydroprocessing, hydrocracking, fluidized cat cracking, dewaxing, delayed coking, fluid coking, partial oxidation, gasification, air blowing, or a combination thereof.

Paragraph T—The method of any of Paragraphs A-S, further comprising adding a deasphalting solvent to the resid-containing stream prior to hydrodynamic cavitation.

Paragraph U—A deasphalted oil rich stream produced by the method of any of Paragraphs A-T.

Paragraph V—A asphaltene rich stream produced by the method of any of Paragraphs A-T.

Paragraph W—A system adapted to perform the method of any of Paragraphs A-T.

Paragraph X—A system for improving deasphalted oil yield or quality from a deasphalting unit comprising: a resid-containing teed stream; a hydrodynamic cavitation unit receiving the resid-containing stream and adapted subject the resid-containing feed stream to hydrodynamic cavitation in a hydrodynamic cavitation unit to convert a portion of hydrocarbons in the resid-containing feed stream to lower molecular weight hydrocarbons and thereby produce a cavitated resid stream; and a deasphalting unit receiving the cavitated resid stream and adapted to subject the cavitated resid stream to solvent deasphalting and separate a deasphalted oil rich stream from an asphaltene rich stream.

What is claimed is:

1. A method of improving deasphalted oil yield or quality from a deasphalting unit comprising:
subjecting a resid-containing stream having an API gravity of less than 22° to hydrodynamic cavitation in a hydrodynamic cavitation unit to convert a portion of hydrocarbons in the resid-containing stream to lower molecular weight hydrocarbons and thereby produce a cavitated resid stream; and
subjecting at least a portion of the cavitated resid stream to deasphalting to separate a deasphalted oil-rich stream from an asphaltene-rich stream.

2. The method of claim 1, wherein the resid-containing stream is at least 50 wt % vacuum or atmospheric resid.

3. The method of claim 1, wherein the resid-containing stream is at least 80 wt % vacuum or atmospheric resid.

4. The method of claim 1, wherein the resid containing stream is vacuum resid.

5. The method of claim 1, wherein the resid-containing stream has a T95 of 1000° F. or greater.

6. The method of claim 1, wherein the resid-containing stream comprises a 1050+° F. boiling fraction, and about 1 to about 35 wt % of the 11050+° F. boiling fraction is converted when subjected to hydrodynamic cavitation.

7. The method of claim 1, wherein the resid-containing stream is subjected to a pressure drop greater than 400 psig when subjected to hydrodynamic cavitation.

8. The method of claim 7, wherein the pressure drop is greater than 1000 psig.

9. The method of claim 8, wherein the pressure drop is greater than 2000 psig.

10. The method of claim 1, wherein the resid-containing stream comprises deasphalted rock from another deasphalting unit.

11. The method of claim 1, wherein the deasphalted oil rich stream has a Ni content that is at least 65% less than that of the resid-containing stream.

12. The method of claim 11, wherein the deasphalted oil rich stream has a content that is at least 70% less than that of the resid-containing stream.

13. The method of claim 1, wherein the deasphalted oil rich stream has a V content that is at least 80% less than that of the resid-containing stream.

14. The method of claim 13, wherein the deasphalted oil rich stream has a V content that is at least 90% less than that of the resid-containing stream.

15. The method of claim 1, wherein the hydrodynamic cavitation is performed in the absence of a catalyst.

16. The method of claim 1, wherein the hydrodynamic cavitation is performed in the absence of hydrogen gas or wherein hydrogen gas is present at a content of less than 50 standard cubic feet per barrel.

17. The method of claim 1, wherein the hydrodynamic cavitation is performed in the absence of water.

18. The method of claim 1, further comprising converting the deasphalted oil rich stream by at least one of fluidized cat cracking or hydrocracking.

19. The method of claim 1, further comprising coking, air blowing, partial oxidation, or gasification of the asphaltene rich stream, or combinations thereof.

20. The method of claim 1, further comprising upgrading the deasphalted oil rich stream by distillation, extraction, hydroprocessing, hydrocracking, fluidized cat cracking, dewaxing, or a combination thereof.

21. The method of claim 1, further comprising adding a portion of the deasphalting solvent to the resid-containing stream prior to hydrodynamic cavitation.

22. The method of claim 21, wherein the portion of solvent added to the resid-containing stream forms a mixed stream with a solubility number that is at least 10 points greater than the insolubility number.

23. A system for improving deasphalted oil yield or quality from a deasphalting unit comprising:
a resid-containing feed stream having an API gravity of less than 22°;
a hydrodynamic cavitation unit receiving the resid-containing stream and adapted to subject the resid-containing feed stream to hydrodynamic cavitation in a hydrodynamic cavitation unit to convert a portion of hydrocarbons in the resid-containing feed stream to lower molecular weight hydrocarbons and thereby produce a cavitated resid stream; and
a deasphalting unit receiving the cavitated resid stream and adapted to subject the cavitated resid stream to solvent deasphalting and separate a deasphalted oil rich stream front an asphaltene rich stream.
